(19) United States
(12) Patent Application Publication
(10) Pub. No.: US 2021/0195346 A1
(43) Pub. Date: Jun. 24, 2021

(54) METHOD, SYSTEM, AND HEARING DEVICE FOR ENHANCING AN ENVIRONMENTAL AUDIO SIGNAL OF SUCH A HEARING DEVICE

(71) Applicant: Audus B.V., Wassenaar (NL)

(72) Inventors: Marciano Benito Ferrier, Wassenaar (NL); Elmer Diederik Bol, Wassenaar (NL); Sukhjinder Singh, Wassenaar (NL)

(21) Appl. No.: 17/270,555

(22) PCT Filed: Aug. 22, 2019
(86) PCT No.: PCT/NL2019/050541

§ 371 Date: Feb. 23, 2021

(30) Foreign Application Priority Data
Aug. 23, 2018 (NL) 2021491

(51) Int. Cl. H04R 25/00; H04R 25/04; G10L 21/0232

(52) U.S. Cl. CPC H04R 25/554; H04R 2225/43; G10L 21/0232; H04R 25/04

(57) ABSTRACT

The invention relates to a method for enhancing an audio signal of a hearing device, comprising the steps of:
using a microphone of the hearing device to receive an environmental audio signal originating from an environment of a user listening to the hearing device,
processing the environmental audio signal by means of a processing unit to enhance the environmental audio signal by suppressing noise and/or amplifying audio data,
outputting the enhanced audio signal to the user listening to the hearing device by means of a speaker,
characterized in that the processing unit is arranged in a communications network, away from the hearing device, wherein the processing unit is configured for receiving the environmental audio signal from the microphone of the hearing device and retransmitting the enhanced audio signal to the speaker of the hearing device via the communications network.

### FIELD OF THE INVENTION

The present invention relates to a method for enhancing an audio signal of a hearing device, comprising the steps of:
using a microphone of the hearing device to receive an environmental audio signal originating from an environment of a user listening to the hearing device,
processing the environmental audio signal by means of a processing unit to enhance the environmental audio signal by suppressing noise and/or amplifying audio data, and
outputting the enhanced audio signal to the user listening to the hearing device by means of a speaker.

### BACKGROUND OF THE INVENTION

WO 2018/083570 A1 discloses an intelligent hearing aid, comprising a microphone, a smartphone and an earphone operatively connected with each other, wherein the microphone is configured for receiving, recording, and transferring environmental audio data to the smartphone. The smartphone is configured for carrying out noise suppression and data amplification on the audio data receiving from the microphone to generate and transfer enhanced audio data to the earphone. The earphone is configured for receiving and outputting the enhanced audio data.

However, a problem with the device according to the above mentioned prior art is that the processing of the audio signal to improve the user's sound perception requires substantial amounts of processing power. This processing generally is carried out by a processor (CPU) or processing unit comprised by the hearing device of the user. In practice, this leads to significantly decreased battery life, an overly complex hearing device, high cost, and, above all, high CPU loads.

Furthermore, when the user carries a hearing aid or the like, to process the environmental audio signal into a signal matching the user's optimal sound perception, the user's comfort is relatively low because of the additional weight of the hearing aid in or on the user's ear. Additionally, the carrying of a hearing device/aid often leads to stigmatization of the user.

US 2015/0199977 A1 furthermore discloses a system for improving speech intelligibility of an audio signal, comprising a hearing aid, a server, and an external device, such as a smartphone or a tablet computer. The hearing aid has a short range transceiver. The server is accessible via the Internet, and has a speech recognition engine converting speech into text. The external device has a short range transceiver for communication with said hearing aid, a second transceiver for providing a wireless data connection to said server via the Internet, means for handling a speech stream intended for the hearing aid, and a text-to-speech engine adapted to synthesize speech based on a string of text. A method of improving speech intelligibility of an audio signal is also disclosed. However, improving the audio signal, for instance compensating for hearing loss, is performed by the digital processor (reference numeral 35 in e.g. FIG. 1 of US 2015/0199977 A1) of the hearing aid itself or by the external device, such as a table or smartphone, as disclosed in paragraphs [0010], [0040], [0046], requiring significant amounts of “local” processing power, battery usage and requiring the user to carry or move many devices around with him or her.

US 2010/0040248 A1 discloses techniques for enhancing a hearing assist device using one or more coprocessor devices. However, the bulk of the signal processing still takes place on the hearing assist device itself.

US 2013/0343584 A1 discloses a hearing assist device, wherein one or more functions are assisted or improved by utilizing resources of an external device. Also with the disclosure of US 2013/0343584 A1 significant amounts of processing may still take place on the hearing assist device itself.

### Object of the Invention

An object of the invention is therefore to provide a method for enhancing an audio signal of a hearing device to improve a user's sound perception, wherein the battery life of the hearing device at the user's side is increased, wherein the user device can be simplified, and importantly, wherein high CPU loads can be prevented.

Another object of the invention is to provide a relatively comfortable hearing device.

Another object of the invention is to provide a hearing device that can be designed such that it is less likely to be seen when a user is wearing the hearing device, such that the user is less likely to be stigmatized.

### DESCRIPTION OF THE INVENTION

Hereto, the method according to the invention is characterized in that the processing unit is arranged in a communications network, away from the hearing device, wherein the processing unit is configured for receiving the environmental audio signal from the microphone of the hearing device and retransmitting the enhanced audio signal to the speaker of the hearing device via the communications network.

Due to the processing of the environmental audio signal into an enhanced audio signal (for the most part) not taking place on the hearing aid itself, the amount of processing power required at the user side is significantly reduced. The processing no longer has to be carried out by a processor (CPU) or processing unit comprised by the hearing device or a similar device, such as a smartphone, arranged at the user's location.

This leads to significantly increased battery life, a relatively less complex hearing device, lower cost, and, lower CPU loads.

The environmental audio signal can be any type of audio signal formed in the vicinity of the user listening to the hearing device, such as a person talking, the wind, vehicles passing by, et cetera, but also audio originating from user equipment near the user, such as a smartphone, laptop, or television.

In the context of this patent application, it should be noted that “hearing device” is to be broadly interpreted as a device capable of improving hearing, not just a conventional in-ear hearing aid.

Furthermore, the noise suppression and audio data amplification algorithms to be used are known to the skilled person, such as from the aforementioned prior art document WO 2018/083570 A1. The expression “away from the hearing device” means that the processing does not take place on the hearing aid itself, nor on—or by—another device to be held or carried by the user. It is conceivable though that processing takes place e.g. on a server arranged in a room where the user is located. Preferably though, the processing unit is for instance arranged on an Internet server or on a server in a cloud computing network.

An embodiment relates to an aforementioned method, wherein the communications network is configured to have a latency of less than 50 ms. An embodiment relates to an aforementioned method, wherein the communications network is configured to have a latency of less than 30 ms.

An embodiment relates to an aforementioned method, wherein the communications network is configured to have a latency of less than 10 ms.

An embodiment relates to an aforementioned method, wherein the communications network is configured to have a latency of 1-5 ms.

An advantage of the abovementioned latencies is that “real-time” communication between the hearing device and the processing unit can take place, wherein a user experiences “real-time” as having latencies of 50 ms or less. With latency is meant the “response time”, being the time it takes for a package to travel from the hearing device, to the processing unit, and from the processing unit to the hearing device, via the communications network. In particular, the inventor found that latencies of less than 50 ms can be achieved via e.g. a 5G network.

An embodiment relates to an aforementioned method, wherein the hearing device is connected to a communications unit with a transmitter for wirelessly transmitting the environmental audio signal from the microphone of the hearing device to the processing unit in the communications network and a receiver for wirelessly receiving the enhanced audio signal from the processing unit in the communications network. This can be achieved, for instance, via a Wi-Fi or Bluetooth connection, possibly with a Wi-Fi or Bluetooth transmitter or receiver close to the user.

An embodiment relates to an aforementioned method, wherein the communications network comprises a further processing unit to further process the enhanced audio signal to match an optimal hearing profile of the user, such as disclosed in Dutch patent application NL 2020909 by the present applicant (the content of which application is herewith incorporated by reference into the present application).

This way, the environmental audio signal can be sent directly to the further processing unit, where it will be processed to match the environmental audio signal with a stored optimal hearing profile stored. Alternatively, the environmental audio signal is first processed by the processing unit to enhance the audio signal by suppressing noise and/or amplifying audio data, and then further processed to match an optimal hearing profile of the user.

Another aspect of the invention concerns a system for enhancing an audio signal of a hearing device, comprising:
a microphone comprised by the hearing device to receive an environmental audio signal originating from an environment of a user listening to the hearing device,
a processing unit for processing the environmental audio signal by means of enhancing the environmental audio signal by suppressing noise and/or amplifying audio data,
a speaker, such as an earphone, configured for outputting the enhanced audio signal to the user listening to the hearing device,
characterized in that the processing unit is arranged in a communications network, away from the hearing device, wherein the processing unit is configured for receiving the environmental audio signal from the microphone of the hearing device and retransmitting the enhanced audio signal to the speaker of the hearing device via the communications network.

An embodiment relates to a system, wherein the hearing device is connected to a communications unit with a transmitter for wirelessly transmitting the environmental audio signal from the microphone of the hearing device to the processing unit in the communications network and a receiver for wirelessly receiving the enhanced audio signal from the processing unit in the communications network.

An embodiment relates to a system, wherein the receiver and the transmitter of the communication unit are configured as a transceiver, which is more compact than a communication unit having a separate transmitter and receiver.

An embodiment relates to a system, wherein the hearing device comprises the communication unit, such that the hearing device is fully self-contained.

An embodiment relates to a system, wherein the communications network is configured to have a latency of less than 50 ms, more preferably of less than 30 ms, even more preferably of less than 10 ms, most preferably of 1-5 ms.

Another aspect of the invention concerns a hearing device for use in the aforementioned method or system, comprising:
a microphone to receive an environmental audio signal originating from an environment of a user listening to the hearing device,
a speaker configured for outputting an enhanced audio signal to the user listening to the hearing device,
a communications unit with a transmitter for wirelessly transmitting the environmental audio signal from the microphone of the hearing device to a processing unit in a communications network and a receiver for wirelessly receiving the enhanced audio signal from the processing unit in the communications network, wherein the processing unit is arranged in the communications network, away from the hearing device, wherein the processing unit is configured for processing the environmental audio signal to enhance the environmental audio signal by suppressing noise and/or amplifying audio data.

### BRIEF DESCRIPTION OF THE DRAWINGS

The present invention will be explained hereafter with reference to exemplary embodiments of the method according to the invention and with reference to the drawings. Therein:

FIG. 1 shows an exemplary embodiment of the system according to the present invention; and

FIG. 2 shows an exemplary embodiment of the system according to the present invention.

### DETAILED DESCRIPTION

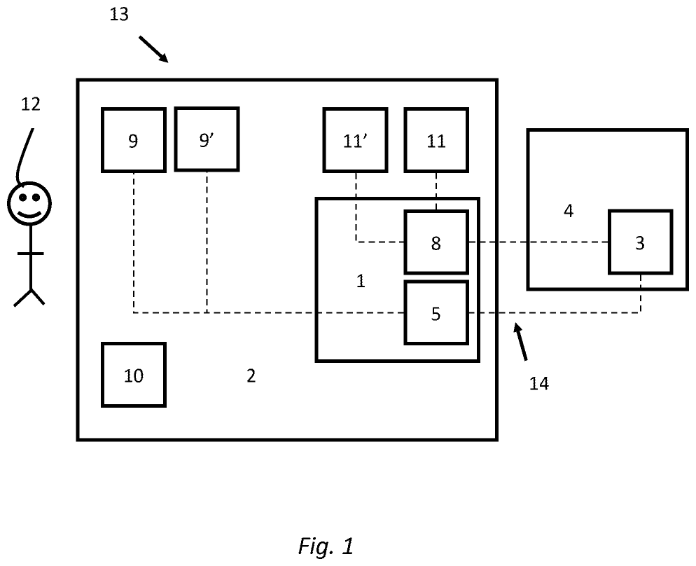

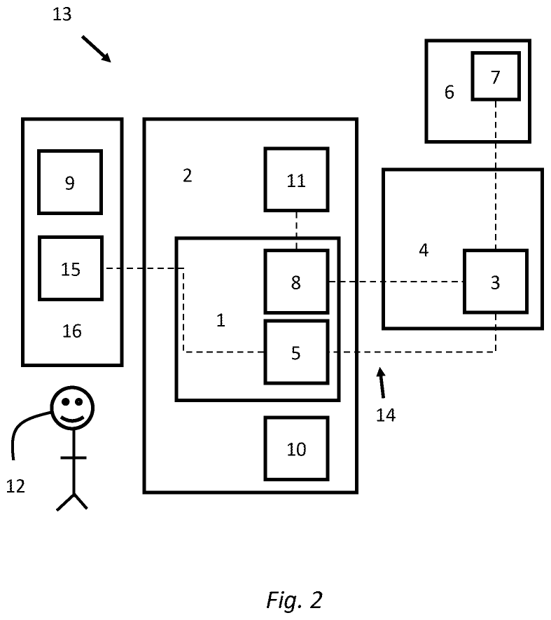

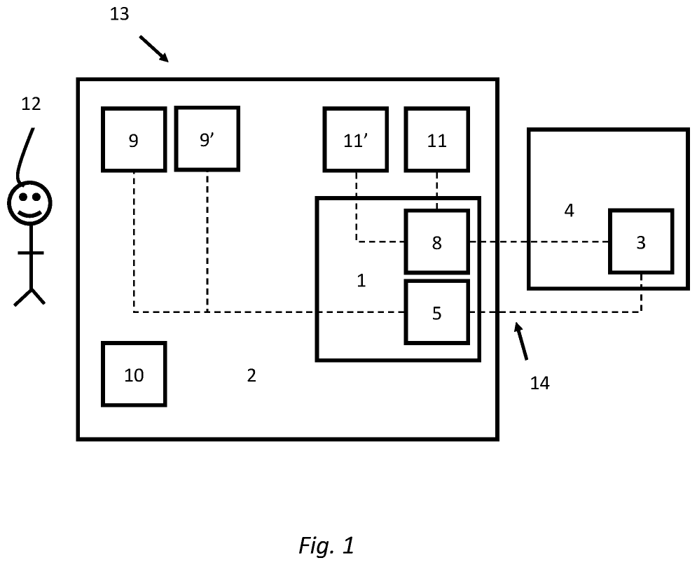

FIG. 1 discloses an exemplary embodiment of the system according to the present invention. The system comprises a hearing device 2 in communication with a processing unit 3, wherein the processing unit 3 is positioned at a server 4. The server 4 is located at a distance from the hearing device 2, wherein the server 4 is in communication with the hearing device 2 via a communication network 14, such as a telecommunication network, or a public communication network such as the internet.

The hearing device 2 comprises a first and a second microphone 11, 11′, a first and a second speaker 9, 9′, a digital analogue converter 10, and a communication unit 1. The communication unit 1 comprises a transmitter 8 and a receiver 5.

The hearing device 2 is, for instance, user equipment such as a smartphone or a hearing to be worn by a user, comprising a sim-card or dedicated chip having similar functionality (not shown), wherein the hearing device is connected to the server 4 over a telecommunication network, such as a 5G telecommunication network.

The transmitter 8 of the communication unit 1 is communicatively connected with the two microphones 11, 11′ of the hearing device 2. With two microphones 11, 11′ it is possible to identify the direction from which an environmental audio signal is coming. The receiver 5 of the communication unit 1 is communicatively connected with speakers 9, 9′ of the hearing device 2. It is also possible that the hearing device 2 comprises a single microphone 11 and/or a single speaker 9.

The transmitter 8 and the receiver 5 are communicatively connected to the processing unit 3. The processing unit 3 is configured to process an audio signal received from the microphone 11, 11′ via the transmitter 8, and for sending a processed audio signal to the speaker 9, 9′ via the receiver 5 of the communication unit 1 which is arranged at the hearing device 2.

The digital-analogue-converter is configured to convert a digital signal into an analogue signal, and vice versa. In this case the digital-analogue-converter is configured to convert an analogue environmental audio signal received by the microphone 11, 11′, prior to sending the environmental audio signal wirelessly to processing unit 3 via the transmitter 8, into a digital signal. After the environmental audio signal is processed by the processing unit 3 into an enhanced audio signal, the enhanced audio signal is communicated to the receiver 5. The digital-analogue-converter then converts the digital enhanced audio signal into an analogue audio signal after which the enhanced audio signal is communicated to the user 12 via speaker 9.

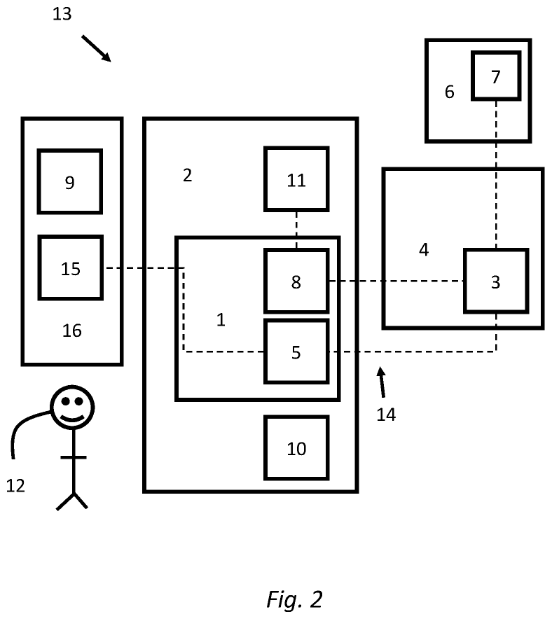

In FIG. 1 it is shown that the speakers 9, 9′ are arranged at hearing device 2. It is however also possible that the speakers 9, 9′ of the hearing device 2 are arranged at a (short) distance from the hearing device 2 as is shown in FIG. 2. The receiver 5 is wirelessly connected to a further receiver 15 of a speaker unit 16 comprising speaker 9 and a digital-analogue-converter (not shown). A connection between the receiver 5 and the further receiver 15 can be, for example, arranged via Bluetooth, or Near Field Communication (NFC). It is, for instance, anticipated that the hearing device 2 with the microphone 11 is arranged on a table in a room near a user 12, wherein the user 12 wears the speaker unit 16.

The speaker unit 16 can be a headset, or a headphone, such as for example, Apple airpods. It is also possible that the speaker unit 16 comprises a single or two earphones 9, 9′ which can, at least partially, be inserted in respectively one or two ears of the user.

In an embodiment the speaker 9 is simply connected with the communication unit 1 via a wire. In this embodiment a speaker unit 16 comprising a digital-analogue-converter and the further receiver 15 is not necessary, whereas it is possible that the speaker 9 is provided at (a relatively short) distance from the hearing device 2.

FIG. 2 discloses an exemplary embodiment of a system 13 for enhancing an audio signal of a hearing device 2. A microphone 11 of the hearing device 2 is configured to receive an environmental audio signal originating from an environment of a user 12 listening to the hearing device 2, i.e. carrying the hearing device 2. The environmental audio signal is processed by means of a processing unit 3 to enhance the environmental audio signal by suppressing noise and/or amplifying audio data. The enhanced audio signal is outputted to the user 12 listening to the hearing device 2 by means of a speaker 9. The processing unit 3 is arranged in a communications network 14, (physically) away from the hearing device 2. The processing unit 3 is configured for receiving the environmental audio signal from the microphone 11 of the hearing device 2 and retransmitting the enhanced audio signal to the speaker 9 of the hearing device 2 via the communications network 14. The communications network 14 is preferably configured to have a latency of less than 50 ms, more preferably of less than 30 ms, even more preferably of less than 10 ms, most preferably of 1-5 ms. There are several factors playing a role in reducing the latency of the communications network 14, such as bandwidth of the communications network 14, load of the communications network 14, contention ratio (ratio of the potential maximum demand to the actual bandwidth), distance from the local exchange, traffic throttling, the load of the server, the network route and the number and magnitude of routing delays incurred. Also, it is expected that the number of nodes in the network influence the latency of the communication network, wherein the more nodes (e.g. router) the more the latency is increased due to a routing delay, as known to the skilled person.

It should be noted that small amounts of final processing may take place on e.g. the hearing aid 2 itself. However, the enhanced audio signal is essentially to be generated/processed nearly fully, such as for 90-100%, or fully, i.e. for 100%, by the processing unit 3 arranged in the communications network 14, such that no audio enhancement processing or only minimal audio enhancement processing and/or final processing need to take place locally, e.g. on the hearing device 2 itself.

Many audio enhancement techniques can be used for suppressing noise and/or amplifying audio data that fall within the scope of the present invention, for example but not limited to, active noise reduction/cancelling, wind noise reduction, impulse noise reduction, occlusion reduction, feedback control, sound smoothing, speech enhancement and/or focus, binaural connection of devices, T-setting, FM compatibility, digital signal processing, multiple channel processing, directional manipulation, sound selection, automatic setting control based on location or environment, multiple memories user defined, motion detection, frequency compression, directional speech enhancement, and audio/video (a/v) synchronisation. Also techniques and algorithms to enhance the elements of music: rhythm, dynamics, melody, harmony, form, timbre and texture are conceivable.

With a/v synchronisation, in particular with regards to lip synchronization during a movie, it was found that a deviation between audio and video is in general undetectable when the audio feed leads the video feed by no more than 100 ms and the audio lags the video by no more than 25 ms, thus when the audio delay time is between −100 ms and +25 ms with respect to the video feed. The deviation in general becomes detectable when the audio delay time is between −125 ms to +45 ms. Moreover, it is considered that an audio delay time between −185 ms to +90 ms is unacceptable. Following the above, the inventors found that, for an in general undetectable a/v synchronization by using the present invention, a connection having a latency of at least 50 ms should be provided, which they found is possible by using a 5G network. Similar estimations can be made for the other audio enhancement techniques.

The hearing device 2 comprises a communications unit 1 with a transmitter 8 for (wirelessly) transmitting the environmental audio signal from the microphone 11 of the hearing device 2 to the processing unit 3 in the communications network 14 and a receiver 5 for (wirelessly) receiving the enhanced audio signal from the processing unit 3 in the communications network 14. Preferably the communications unit 1 is physically contained in or by the hearing device 2.

The processing unit 3 is in communication with a storage unit 6 comprising a database 7. The storage unit 6 can also be arranged at the server 4. Preferably, the database contains a multitude of optimal hearing profiles associated with a respective multitude of users 12. Each optimal hearing profile comprises information of a user's 12 hearing range. By accessing the database 7, it is possible to take into account a user's 12 optimal hearing profile when processing the environmental audio signal into the enhanced audio signal. This way, the noise suppression and/or amplification can be based, albeit partly, on the optimal hearing profile of a user 12. This can be highly advantageous for instance when multiple users 12 are participating (simultaneously) in an online meeting, such as a Skype, Goto or Zoom meeting, with each user 12 being able to hear optimal sound, without having to locally process audio signals to produce enhanced audio signals.

A method for enhancing an audio signal of a hearing device 2 in accordance with the present invention comprises the steps of:
receiving, via a microphone 11 of the hearing device 2, an environmental audio signal originating from an environment of a user 12 listening to the hearing device 2;
sending the environmental audio signal, via a transmitter 8 of a communication unit 1, to a processing unit 3 arranged at a server 4, wherein the processing unit 3 is arranged at a distance from the communication unit 1 and connected thereto via a communication network 14;
processing, by the processing unit 3, the environmental audio signal thereby forming an enhanced environmental audio signal by suppressing noise and/or amplifying audio data;
communicating, by the processing unit 3, the enhanced audio signal via a receiver 5 of the communication unit 1 to a speaker 9; and
outputting the enhanced audio signal to the user 12 listening to the hearing device 2 via the speaker 9.

It should be clear that the description above is intended to illustrate the operation of preferred embodiments of the invention, and not to reduce the scope of protection of the invention. Starting from the above description, many embodiments will be conceivable to the skilled person within the inventive concept and scope of protection of the present invention.

### LIST OF REFERENCES

1. Communication unit
2. Hearing device
3. Processing unit
4. Server
5. Receiver
6. Storage unit
7. Database
8. Transmitter
9. Speaker/earphone
10. (Digital-to-analog) converter
11. Microphone
12. User
13. System
14. Communications network
15. Further receiver
16. Speaker unit

1. A method for enhancing an audio signal of a hearing device, comprising the steps of:
using a microphone of the hearing device to receive an environmental audio signal originating from an environment of a user listening to the hearing device,
processing the environmental audio signal by means of a processing unit to enhance the environmental audio signal by suppressing noise and/or amplifying audio data,
outputting the enhanced audio signal to the user listening to the hearing device by means of a speaker,
characterized in that the processing unit is arranged in a communications network, away from the hearing device, wherein the processing unit is configured for receiving the environmental audio signal from the microphone of the hearing device and retransmitting the enhanced audio signal to the speaker of the hearing device via the communications network.

2. The method according claim 1, wherein the communications network is configured to have a latency of less than 50 ms.

3. The method according to claim 1, wherein the communications network is configured to have a latency of less than 30 ms.

4. The method according to claim 1, wherein the communications network is configured to have a latency of less than 10 ms.

5. The method according to claim 1, wherein the communications network is configured to have a latency of 1-5 ms.

6. The method according to claim 1, wherein the hearing device is connected to a communications unit with a transmitter for wirelessly transmitting the environmental audio signal from the microphone of the hearing device to the processing unit in the communications network and a receiver for wirelessly receiving the enhanced audio signal from the processing unit in the communications network.

7. The method according to claim 1, wherein the communications network comprises a further processing unit to further process the enhanced audio signal to match an optimal hearing profile of the user.

8. A system for enhancing an audio signal of a hearing device, comprising:
a microphone comprised by the hearing device to receive an environmental audio signal originating from an environment of a user listening to the hearing device,
a processing unit for processing the environmental audio signal by means of enhancing the environmental audio signal by suppressing noise and/or amplifying audio data,
a speaker configured for outputting the enhanced audio signal to the user listening to the hearing device,
characterized in that the processing unit is arranged in a communications network, away from the hearing device, wherein the processing unit is configured for receiving the environmental audio signal from the microphone of the hearing device and retransmitting the enhanced audio signal to the speaker of the hearing device via the communications network.

9. The system according to claim 8, wherein the hearing device is connected to a communications unit with a transmitter for wirelessly transmitting the environmental audio signal from the microphone of the hearing device to the processing unit in the communications network and a receiver for wirelessly receiving the enhanced audio signal from the processing unit in the communications network.

10. The system according to claim 9, wherein the receiver and the transmitter of the communication unit are configured as a transceiver.

11. The system according to claim 8, wherein the hearing device comprises the communication unit.

12. The system according to claim 8, wherein the communications network is configured to have a latency of less than 50 ms, more preferably of less than 30 ms, even more preferably of less than 10 ms, most preferably of 1-5 ms.

13. The system according to claim 8, wherein the processing unit is in communication with a storage unit comprising a database containing an optimal hearing profile associated with the user.

14. The system according claim 13, wherein the processing unit is in communication with a storage unit comprising a database containing a multitude of optimal hearing profiles associated with a respective multitude of users, wherein each user's optimal hearing profile is taken into account when processing the environmental audio signal into the enhanced audio signal.

15. A hearing device, comprising:
a microphone to receive an environmental audio signal originating from an environment of a user listening to the hearing device,
a speaker configured for outputting an enhanced audio signal to the user listening to the hearing device,
a communications unit with a transmitter for wirelessly transmitting the environmental audio signal from the microphone of the hearing device to a processing unit in a communications network and a receiver for wirelessly receiving the enhanced audio signal from the processing unit in the communications network, wherein the processing unit is arranged in the communications network, away from the hearing device, wherein the processing unit is configured for processing the environmental audio signal to enhance the environmental audio signal by suppressing noise and/or amplifying audio data, wherein the hearing device is configured to perform the following steps:
using the microphone of the hearing device to receive an environmental audio signal originating from an environment of a user listening to the hearing device,
processing the environmental audio to enhance the environmental audio signal by suppressing noise and/or amplifying audio data,
outputting the enhanced audio signal to the user listening to the hearing device by means of a speaker.
